(19) United States
(12) Patent Application Publication
(10) Pub. No.: US 2011/0153601 A1
(43) Pub. Date: Jun. 23, 2011

(54) INFORMATION ANALYSIS APPARATUS, INFORMATION ANALYSIS METHOD, AND PROGRAM

(76) Inventors: Satoshi Nakazawa, Tokyo (JP); Shinichi Ando, Tokyo (JP); Takao Kawai, Tokyo (JP); Yuzuru Okajima, Tokyo (JP)

(21) Appl. No.: 13/060,572

(22) PCT Filed: Sep. 18, 2009
(86) PCT No.: PCT/JP2009/004752

§ 371 Date: Feb. 24, 2011

(30) Foreign Application Priority Data
Sep. 24, 2008 (JP) 2008-244753

(51) Int. Cl. G06F 17/30

(52) U.S. Cl. 707/723; 707/E17.014

(57) ABSTRACT

An information analysis apparatus 1 that executes information analysis on a document set including documents to which time information is attached, the apparatus includes: a corresponding section selection unit 30 that mutually compares a plurality of time-series data generated and selects two or more sections that change corresponding to each of two or more sections of another time-series data from each time-series data; a feature extraction unit 40 that extracts features from the documents belonging to the selected two or more sections; a comparison unit 50 that acquires, from extracted features, an inter-feature distance of the selected one section and another section, and mutually compares the inter-feature distances of each of the time-series data; and a correlation degree calculation unit 70 that calculates a degree of correlation between the document sets based on the comparison result.

### TECHNICAL FIELD

The present invention relates to an information analysis apparatus, an information analysis method, and a program in which analysis on a document set is executed.

This application claims priority to and the benefit of Japanese Patent Application No. 2008-244753 filed on Sep. 24, 2008, the disclosure of which is incorporated herein by reference.

### BACKGROUND ART

In recent years, for document data analysis, a determination on a degree of similarity or correlation between two document groups has been performed. For example, the determination on the degree of similarity is performed based on the number of linguistic expressions commonly present between two document sets or an amount of information included in each document set (see Non-Patent Document 1).

Specifically, Non-Patent Document 1 discloses a technique of obtaining the degree of similarity between two documents in order to group similar documents and sort texts. In Non-Patent Document 1, the degree of similarity between two documents is defined by a formula using the number of index words (one of linguistic expressions) commonly appearing in the both documents. A pair of document sets (a cluster pair) having a the highest degree of similarity is merged into one group by using a maximum value of the degrees of similarity belonging to each document set as the degree of similarity between the two document sets (clusters).

In the present disclosure, “linguistic expression” refers to a description representing a noun, a topic, an opinion, or an object included in a document (a text). For example, “linguistic expression” includes a nominal expression expressed by a noun such as an event name, a case name, and a product name and an expression in which a nominal expression is combined with a predicate or a modifier. “Racing game,” “food fraud,” and “aseismatic gel” are included as specific examples of nominal expressions. “Aseismatic gel is effective” and “diesel engines are good for the environment” are included as specific examples of the combined expression.

Further, “linguistic expression” may be a character string itself that appears in a document or an analysis result obtained by applying an existing natural language processing technique such as morphological analysis, syntactic analysis, dependency analysis, or synonym processing to the documents. For example, “school” and “student” are linguistic expressions, each of which includes one word. A result of the dependency analysis between words such as “school→go,” which is obtained by performing the dependency analysis on a text such as “go to school” and “went to school in a hurry,” is also a linguistic expression representing one definite meaning.

Separately from the above described analysis based on the determination on the degree of similarity or correlation between the two documents, analysis on document data has also been performed by investigating a temporal change in the number of document sets including a specific linguistic expression. This point will be described below.

In recent years, a large amount of document data having a transmission date and time, a creation date and time, or an answering date and time as in blogs on the Internet, electronic mails, and an answering history in a call center have been created and become accessible. The number of times that a linguistic expression of interest appears or the number of times that it becomes a topic can be investigated by extracting documents using a specific linguistic expression of interest from a document set containing documents with time information, lining up the extracted documents in order based on the time information added thereto, and performing time-series analysis (see Non-Patent Document 2).

Specially, Non-Patent Document 2 discloses a technique called “Blog Watcher.” In this technique, a time-series change in the number of times that a specific topic word appears in all of collected blogs, the number of times that the topic word is positively stated in all of collected blogs, and the number of times that the topic word is negatively stated in all of collected blogs is plotted as a line graph. According to the technique disclosed in Non-Patent Document 2, a user can investigate a change in the number of times that a topic word of interest appears in blogs and perform analysis on how popular the topic word of interest was at each point in time.

Further, as a basic technique of statistical analysis, there is regression analysis. This technique detects an event having a high degree of correlation by investigating correlativity of a temporal change between a plurality of time-series data when a plurality of time-series data such as the number of times that a certain event appears at each point in time or the price is present. For example, when a temporal change in a certain stock price is correlated with a temporal change in another stock price, it is possible to calculate the degree of correlation between the two prices by performing regression analysis using the two stock prices at each point in time as time-series data, respectively.

Let us consider a case in which an event of interest is an event expressed by a specific linguistic expression. For example, when a document set containing documents with time information is given as an analysis target instead of direct time-series data such as a stock price, the time-series data of each linguistic expression can be obtained by the technique disclosed in Non-Patent Document 2. In this case, if the document set as an analysis population is broken into specific time periods using time information, the number of documents including each linguistic expression or the number of times that a linguistic expression appears at each time period can be used as time-series data of each linguistic expression at each time period.

Therefore, using the technique disclosed in Non-Patent Document 2, the degree of correlation between two document sets can be obtained by converting the two document sets with time information into two time-series data and then investigating correlativity between the two documents based on the statistical analysis such as the regression analysis. In this case, it does not matter whether or not the same or similar linguistic expression is present in the two documents with time information. The two document sets with time information are regarded as time-series data, and the degree of correlation between the two document sets is obtained based on similarity or correlativity between change patterns of the two document sets.

That is, even though many same or similar linguistic expressions are not necessarily included in the two document sets, if it is determined that correlativity between temporal changes of time-series data of the two document sets is high, the high degree of correlation between the two input document sets is calculated. As described above, if the technique disclosed in Non-Patent Document 2 is combined with the statistical analysis such as the regression analysis, the degree of similarity or correlation between the two document sets with time information can be determined.

However, if the degree of correlation between a plurality of time-series data is obtained by investigating the similarity or correlativity between the change patterns of time-series data using the statistical analysis such as the regression analysis, there exists a problem in that the correlativity can be erroneously evaluated as high due to an accidental coincidence.

For example, let us assume that there are time-series data (1) and time-series data (2) as illustrated in FIG. 2. FIG. 2 is a diagram illustrating an example of time-series data as will be described later. In the example shown in FIG. 2, two peaks are present in both the time-series data (1) and the time-series data (2) in the same time period. Therefore, if only the time-series data illustrated in FIG. 2 is considered, the correlativity is high.

Of course, a causal relationship that one causes the other to change may exist between the time-series data (1) and the time-series data (2) and high correlativity may be appropriate. However, for example, there is a case in which the two peaks of the time-series data (1) are based on two different causes and independent of each other, but the two peaks of the time-series data (2) are periodical peaks based on any other cause. That is, there is a case in which the sections of the peaks of the time-series data (1) and the time-series data (2) overlap by chance.

For this reason, if using the technique disclosed in Non-Patent Document 2, the two document sets with time information are converted into two time-series data, and then the correlativity between the two documents is investigated by the statistical analysis such as the regression analysis, it is difficult to determine whether it is a coincidence or there is really correlativity therebetween.

Further, a technique of obtaining similarity between a document set as one time-series data source and a document set as another time-series data source and obtaining the degree of correlation between the time-series data based on the obtained similarity by applying a disclosure technique to Non-Patent Document 1 may be considered. In this case, the degree of similarity between the two document sets is calculated based on the frequency in which the same or similar linguistic expression appears in the two document sets.

However, in this case, regardless of whether or not there is correlativity between the two document sets, since the same or similar content is not stated, correlativity may not be appropriately determined. Specially, even if there is a causal relationship between an event stated in one document set and an event stated in the other document set, the same or similar linguistic expression may not be used in the two document sets. Further, even if a common cause is stated in each of the two document sets, the results on the common cause may be different in the document sets.
Non-Patent Document 1: Edited by Nagao Makoto, “Natural Language Processing,” Iwanami Shoten, 1996, ISBN4-00-010355-5, P. 436-438
Non-Patent Document 2: Tomoyuki Nanno, Yasuhiro Suzuki, Toshiaki Fujiki, Manabu Okumura, “Automatic Collection and Monitoring of Blogs,” Journal of JSAI, Vo. 19 (2004), No. 6, PP. 511-520

### DISCLOSURE OF INVENTION

### Problem to be Solved by the Invention

In order to solve the above problems, it is an object of the present invention to provide an information analysis apparatus, an information analysis method, and a program in which a coincidence between change patterns of time-series data obtained from a plurality of document sets with time information is prevented from having an influence on determination as to whether or not there is correlativity between the document sets.

### Means for Solving the Problem

To solve the above described problem, according to an aspect of the present invention, there is provided an information analysis apparatus that executes information analysis on a document set including documents to which time information is attached, the apparatus including:

a corresponding section selection unit that mutually compares a plurality of time-series data generated based on the time information, from a plurality of document sets for each of the document sets and selects two or more sections that change corresponding to each of two or more sections of another time-series data from each time-series data;

a feature extraction unit that specifies the documents belonging to the selected two or more sections for each section on each of the plurality of time-series data and extracts features of the specified documents for each section;

a comparison unit that acquires an inter-feature distance between a feature extracted from one section of the selected two or more sections and a feature extracted from another section for each time-series data and mutually compares the acquired inter-feature distances of each of the time-series data; and

a correlation degree calculation unit that calculates a degree of correlation between the document sets based on the comparison result obtained by the comparison unit.

In addition, to solve the above described problem; according to an aspect of the present invention, there is provided an information analysis method of executing information analysis on a document set including documents to which time information is attached, the method including:

(a) a step of mutually comparing a plurality of time-series data generated based on the time information, from a plurality of document sets for each of the document sets and selecting two or more sections that change corresponding to each of two or more sections of another time-series data from each time-series data;

(b) a step of specifying the documents belonging to the selected two or more sections for each section on each of the plurality of time-series data and extracting features of the specified documents for each section;

(c) a step of acquiring an inter-feature distance between a feature extracted from one section of the selected two or more sections and a feature extracted from another section for each time-series data and mutually comparing the acquired inter-feature distances of each of the time-series data; and

(d) a step of calculating a degree of correlation between the document sets based on the comparison result obtained in step (c).

In addition, to solve the above described problem, according to an aspect of the present invention, there is provided a program for causing a computer to execute information analysis on a document set including documents to which time information is attached, the program further causing the computer to execute:

(a) a step of mutually comparing a plurality of time-series data generated, based on the time information, from a plurality of document sets for each of the document sets and selecting two or more sections that change corresponding to each of two or more sections of another time-series data from each time-series data;

(b) a step of specifying the documents belonging to the selected two or more sections for each section on each of the plurality of time-series data and extracting features of the specified documents for each section;

(c) a step of acquiring an inter-feature distance between a feature extracted from one section of the selected two or more sections and a feature extracted from another section for each time-series data and mutually comparing the acquired inter-feature distances of each of the time-series data; and

(d) a step of calculating a degree of correlation between the document sets based on the comparison result obtained in step (c).

### Effect of the Invention

As described above, according to the present invention, a coincidence between change patterns of time-series data obtained from a plurality of document sets with time information is prevented from having an influence on determination as to whether or not there is correlativity between the document sets.

### BRIEF DESCRIPTION OF THE DRAWINGS

FIG. 1 is a block diagram illustrating a schematic configuration of an information analysis apparatus according to a first embodiment of the present invention.

FIG. 2 illustrates an example of time-series data.

FIG. 3 illustrates an example of time-series data.

FIG. 4 illustrates an example of time-series data.

FIG. 5 illustrates an example of time-series data.

FIG. 6 illustrates an example of time-series data that changes by a common cause.

FIG. 7 illustrates another example of time-series data that changes by a common cause.

FIG. 8 illustrates another example of time-series data that changes by different causes.

FIG. 9 is a flowchart illustrating the process flow in an information analysis method according to the first embodiment of the present invention.

FIG. 10 is a block diagram illustrating a schematic configuration of an information analysis apparatus according to a second embodiment of the present invention.

FIG. 11 is a flowchart illustrating the process flow in an information analysis method according to the second embodiment of the present invention.

### BEST MODE FOR CARRYING OUT THE INVENTION

### First Embodiment

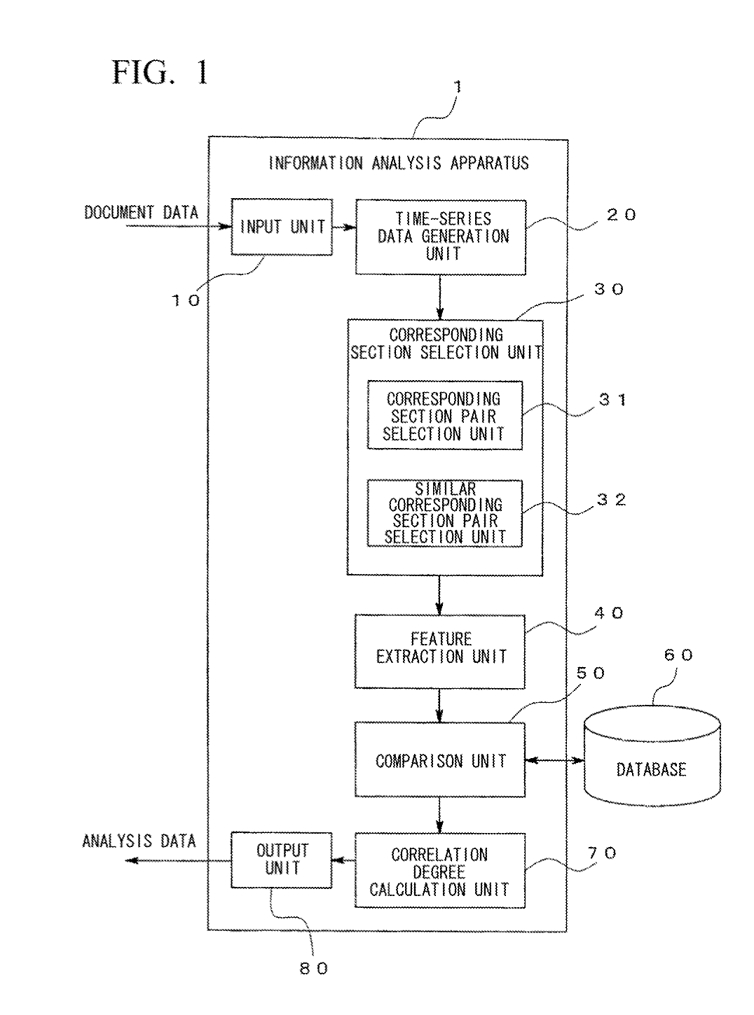

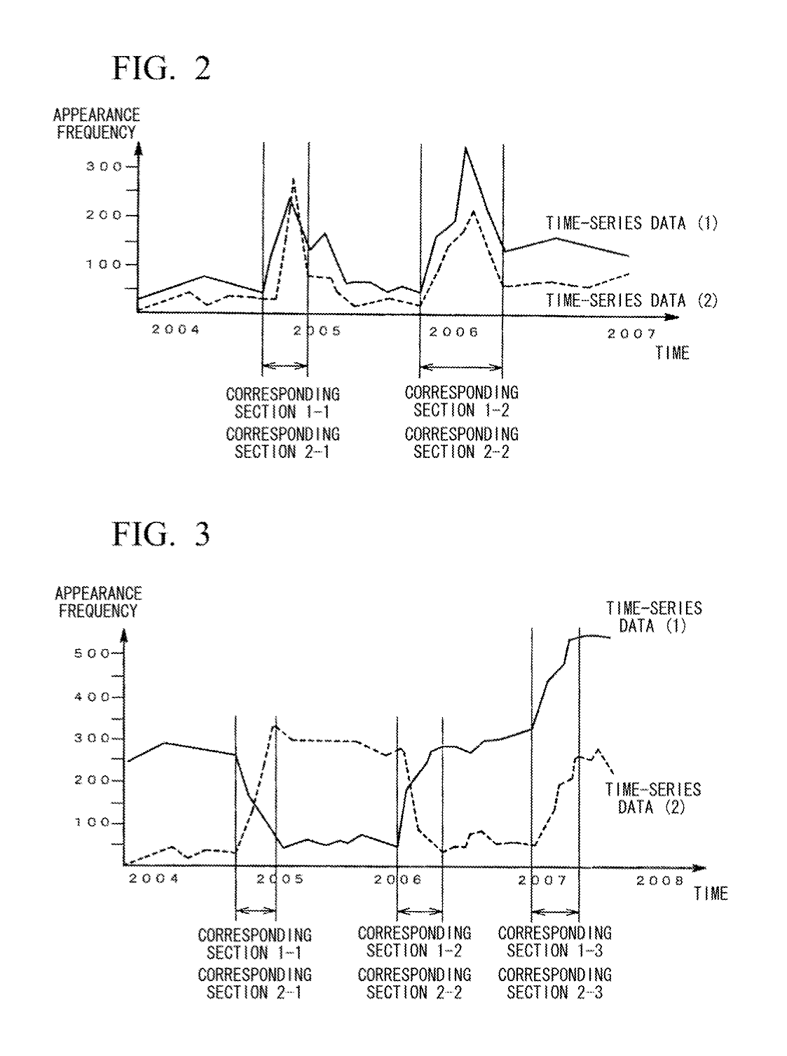

Hereinafter, an information analysis apparatus, an information analysis method, and a program according to a first embodiment of the present invention will be described with reference to FIGS. 1 to 9. First, a configuration of the information analysis apparatus according to the first embodiment of the present invention will be described with reference to FIGS. 1 to 5. FIG. 1 is a block diagram illustrating a schematic configuration of the information analysis apparatus according to the first embodiment of the present invention. FIGS. 2 to 5 each illustrate examples of time-series data.

An information analysis apparatus 1 illustrated in FIG. 1 is an apparatus that executes information analysis on the document sets containing documents to which time information is attached. As illustrated in FIG. 1, the information analysis apparatus 1 includes a corresponding section selection unit 30, a feature extraction unit 40, a comparison unit 50, and a correlation degree calculation unit 70. The document set as an analysis target includes a plurality of text data to which time information is added and is input to the information analysis apparatus 1 from the outside.

According to the first embodiment, the information analysis apparatus 1 further includes an input unit 10, a time-series data generation unit 20, and an output unit 80 as illustrated in FIG. 1. The information analysis apparatus 1 is connected to a database 60. The database 60 is used for processing performed by the comparison unit 50 as will be described later. Hereinafter, a description will be made in connection with a case in which two document sets are input, and two time-series data that change corresponding to each other are generated.

The input unit 10 receives a plurality of document sets as an analysis target. The document data that constitutes the document set is input to the input unit 10. At this time, the document data that constitutes the document set may be input to the input unit 10 from a computer apparatus directly or via a network or may be supplied in a form of a recording medium storing it. In the former case, as the input unit 10, an interface for connecting the information analysis apparatus 1 with the outside is used. In the latter case, as the input unit 10, a reading apparatus is used.

In the first embodiment, as described above, the two document sets are input. As will be described later, the degree of correlation between the input two document sets is calculated and finally output to the outside through the output unit 80. In this disclosure, for convenience, if the two input documents need to be separately described, the two documents are denoted as an input document set (1) and an input document set (2). Further, when the two document sets are input, the document set to be denoted as the input document set (1) or the input document set (2) is not specifically limited but may be suitably set.

The input document set is a set of documents (document data) to which time information is attached as described above. Here, “time information” refers to time information such as a date (year-month-day) or a time attached to each of documents belonging to the input document set. As “time information,” time information directly related to each document such as a creation date and time, a transmission date and time, and a publication date and time of each document may be used. Further, as “time information,” time information related to an issue and an event dealt with in the contents of the document may be used. Specific examples of the time information include a call receiving date and time recorded in an answering record created in the call center or a date and time of occurrence of an accident recorded in the police accident record.

Further, in the first embodiment, one document may include a plurality of pieces of time information. In this case, however, it is necessary to set time information to be used as time information specific to a corresponding document in advance, through the time-series data generation unit 20 which will be described later. The time-series data generation unit 20 extracts only time information of a previously set kind.

The time information may have a format in which the documents belonging to the input document set can be ordered over time or a format having one of a year-month-day of the Western calendar, a combination of a year-month-day and a time, or a year-month. Examples of the input document set include a blog article containing a linguistic expression (or a synonymous expression) such as “bought a snack A” or a blog article containing a linguistic expression (or a synonymous expression) such as “an idol B's dancing is good.” In this case, a date of each blog article is the time information.

The time-series data generation unit 20 generates a plurality of time-series data for each of the document sets, based on the time information, from the plurality of document sets received by the input unit 10. According to the first embodiment, since the time-series data generation unit 20 is included, the document set may be input directly to the information analysis apparatus 1. In the first embodiment, the two document sets are input, and the time-series data generation unit 20 generates two time-series data. In this disclosure, for convenience, the time-series data generated from the input document set (1) is denoted as “time-series data (1),” and the time-series data generated from the input document set (2) is denoted as “time-series data (2).”

In this description, “time-series data” refers to data obtained by dividing a time by a specific time period and lining up an arbitrary counting result in each divided section or in a specific point of each section such as a front or a central point of each section in time order. Although not time-series data generated from the document set, a stock price of a specific company at each date is a typical example of the time-series data. In this case, the specific time period is one day. Further, a temporal change in temperature and a temporal change in traffic in a specific road can be included as the time-series data even though they are not time-series data generated from the document set.

In the first embodiment, in order to generate the time-series data from the document set, the time-series data generation unit 20 first divides the document set by a specific time period based on the time information attached to each document and generates a plurality of subsets. At this time, the length of the specific time period is not specifically limited but may be suitably set according to a use or an intended purpose of the information analysis apparatus 1 or a characteristic of the time information attached to the documents that constitute the document set.

For example, let us assume that the time information attached to the document was a date of the Western calendar, the oldest document was created on Jan. 1, 2005, and the specific time period was one month. In this case, the time-series data generation unit 20 divides one document set into a plurality of document sets such as a document set of documents with the time information of January of 2005, a document set of documents with the time information of February of 2005, and a document set of documents with the time information of March of 2005. The time-series data generation unit 20 obtains a value (an arbitrary counting result) defined from characteristics of the documents that constitute each subset for each of the document sets (subsets) obtained by division and sorts the obtained values in time order as time-series data.

Further, “a value defined from characteristics of the documents” is preferably a value that can be uniquely calculated mechanically from a characteristic of the document that constitutes each subset and is suitably set according to a purpose or use of the information analysis apparatus 1 and a kind of meta information attached to each document. Specifically, “a value defined from characteristics of the documents” includes the number or the size of the documents that constitute each subset and the number of unique senders of the documents that constitute each subset.

“The number of unique senders of the documents” refers to the actual number of senders that send each document and does not include the total number obtained by counting the same person multiple times. If a numerical value that cannot be calculated mechanically from the contents of the document like the number of unique senders is used, information specifying a numerical value (for example, information specifying the sender like a sender ID) needs to be attached to each document as meta information of the document, separately from the time information.

Here, examples of the time-series data will be described. In the examples of FIGS. 2 to 8, the time-series data (1) generated from the input document set (1) and the time-series data (2) generated from the input document set (2) are illustrated. The time-series data (1) and (2) can be expressed by a graph in which a horizontal axis denotes time and a vertical axis denotes a counting result. In FIGS. 2 to 8, the counting results from 2004 to 2007 (2008 in FIG. 3) are plotted.

In FIGS. 2 to 8, as the counting results of the vertical axis, the number of times that a specified feature word or similar word appeared during a set time period (the appearance frequency) is used. Further, the counting result that can be used as the vertical axis in the time-series data may be a measured value itself such as the appearance frequency or a value obtained by correcting or converting an original numerical value. Examples of the latter case include a value obtained by normalizing a measured value by using the number of all document sets or a value obtained by differentiating a change of a measured value. Whether to perform a correction or conversion or to use the measured value itself is suitably selected according to a use or intended purpose of the information analysis apparatus 1 or a characteristic of the input document.

The corresponding section selection unit 30 mutually compares a plurality of time-series data obtained from the plurality of document sets and selects two or more sections (corresponding sections) that change corresponding to each of two or more sections of other time-series data from each time-series data. In the first embodiment, the corresponding section selection unit 30 mutually compares the time-series data (1) and the time-series data (2) and selects two or more sections (corresponding sections) that change corresponding to each other from each time-series data. The corresponding section selection unit 30 outputs the two or more corresponding sections of each of the selected time-series data to the feature extraction unit 40.

Further, in the first embodiment, the corresponding section selection unit 30 includes a corresponding section pair selection unit 31 and a similar corresponding section pair selection unit 32 to perform corresponding section selection, which will be described below.

The corresponding section pair selection unit 31 investigates correlativity between the two time-series data and selects sections (corresponding sections) that change corresponding to each other between the two time-series data. The corresponding section pair selection unit 31 receives the time-series data (1) and the time-series data (2) from the time-series data generation unit 20, detects one section of one time-series data and one section of the other time-series data that changes corresponding thereto, and selects the two sections as a corresponding section pair in the time-series data (hereinafter, referred to as “corresponding section pair”). The corresponding section pair selection unit 31 selects two or more corresponding section pairs from the time-series data (1) and the time-series data (2).

Here, “sections that changes corresponding to each other (corresponding sections)” refers to one partial section in which there is high correlativity between a graph obtained by plotting a value of a certain one partial section of the time-series data (1) and a graph obtained by plotting a value of a certain one partial section of the time-series data (2). According to the first embodiment, the determination as to whether or not there is high correlativity may be performed by using a correlation coefficient.

Specially, the corresponding section pair selection unit 31 first obtains a correlation coefficient between the time-series data (1) and the time-series data (2). The corresponding section pair selection unit 31 can select two or more sections, which have a value exceeding (more than or equal to) a threshold value in which an absolute value of a correlation coefficient is set in each of the two time-series data, as the corresponding sections. At this time, the threshold value is previously set to a suitable value so that two or more corresponding section pairs can be selected in the time-series data assumed as an input in view of a characteristic of the document set as a source of the time-series data or a change status of the time-series data.

Since the absolute value of the correlation coefficient is used in determination, the obtained correlation coefficient may be a negative value. Further, the general Pearson's product-moment correlation coefficient, the Spearman('s) rank-correlation coefficient, or the Kendall's rank correlation coefficient may be used as the correlation coefficient. If two or more corresponding section pairs cannot be selected, the corresponding section pair selection unit 31 may set the threshold value once again to decrease the previously set threshold value or instruct the correlation degree calculation unit 70 to stop calculating the degree of correlation.

Further, in the first embodiment, the corresponding section pair selection unit 31 may determine correlativity between a partial section of one time-series data and a partial section of another time-series data by using an existing statistical analysis technique or time-series analysis technique instead of using the correlation coefficient. As the selection criterion of the corresponding section pair, instead of the magnitude of correlativity between the partial sections of the two time-series data, the corresponding section pair selection unit 31 may detect sections in which one or both of the time-series data characteristically changes and use the degree thereof as the selection criterion. For example, the sections in which the graphs of one or both of the time-series data greatly change, respectively, are detected, and the corresponding section pair can be selected in view of the degree of change in the sections.

The graph of FIG. 2 illustrates an example of corresponding section pair selection. In the graph of FIG. 2, two peaks having the convex in the upper position are commonly present in both the time-series data (1) and the time-series data (2). In this case, the correlation coefficient between the time-series data is a high positive value, and the time-series data (1) and the time-series data (2) have high peak correlativity. Therefore, the two peaks can be selected as the corresponding section pair, respectively.

In the graph of FIG. 3, from the last half of 2004 to early 2005, the appearance frequency of the time-series data (1) abruptly decreases, whereas the appearance frequency of the time-series data (2) abruptly increases. On the other hand, in early 2006, the appearance frequency of the time-series data (1) abruptly increases, whereas the appearance frequency of the time-series data (2) abruptly decreases. In the case of FIG. 3, the correlation coefficient is negative, but the absolute value thereof is large. The correlativity between the abruptly increasing parts and the abruptly decreasing parts of the two time-series data is considered high. Therefore, the sections of the abruptly increasing part and the abruptly decreasing part of the two time-series data can be selected as the corresponding section pair.

In FIGS. 2 to 8, for convenience of description, the corresponding sections of the time-series data are denoted as a corresponding section 1-1, a corresponding section 2-1, a corresponding section 1-2, and a corresponding section 2-2. In this case, the corresponding section 1-1 represents a first corresponding section of the time-series data (1), and the corresponding section 1-2 represents a second corresponding section of the time-series data (1). A corresponding section 1-n represents an n-th corresponding section of the time-series data (1).

Similarly, the corresponding section 2-1 represents a first corresponding section of the time-series data (2), and the corresponding section 2-2 represents a second corresponding section of the time-series data (2). A corresponding section 2-n represents an n-th corresponding section of the time-series data (2). When numerical values applied to “n” are equal in the corresponding section 1-n and the corresponding section 2-n, the corresponding section 1-n and the corresponding section 2-n are the corresponding section pair having the correspondence relationship. For example, the corresponding section 1-1 and the corresponding section 2-1 are the corresponding section pair having the correspondence relationship.

In each of the corresponding section pairs illustrated in FIGS. 2 and 3, the corresponding sections having the correspondence relationship are equal in length, start time, and finish time. However, the first embodiment is not limited thereto, and the corresponding sections having the correspondence relationship need not necessarily be equal in length, start time, and finish time.

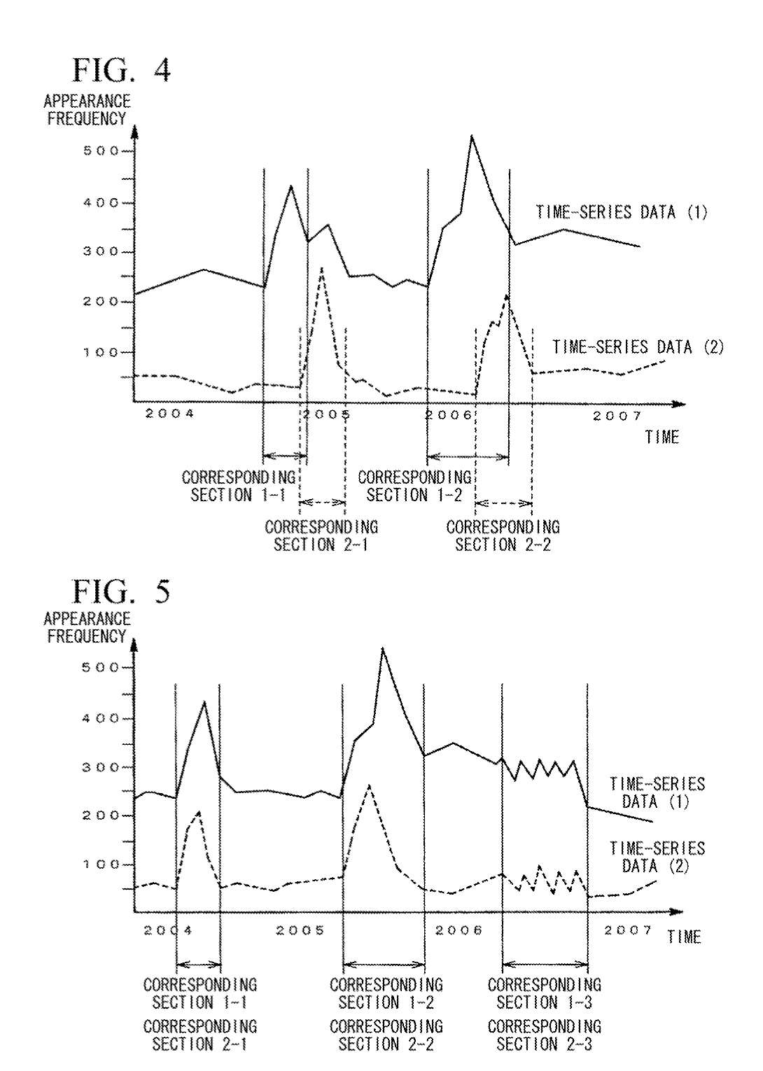

For example, like a pair of the corresponding section 1-1 and the corresponding section 1-2 and a pair of the corresponding section 1-2 and the corresponding section 2-2 illustrated in FIG. 4, the corresponding sections as a pair may be misaligned in start time and finish time. Further, like a pair of the corresponding section 1-2 and the corresponding section 2-2 illustrated in FIG. 4, the length may be different.

In selecting the corresponding section pair from the two time-series data, allowable misalignment in start time and finish time or allowable difference in length depends on a technique of obtaining the corresponding section pair to use, that is, a technique of determining correlativity.

The similar corresponding section pair selection unit 32 investigates correlativity between partial sections on a plurality of partial sections that are present in one time-series data and performs selection on ones selected as the corresponding sections. The similar corresponding section pair selection unit 32 further selects the corresponding section pairs that are similar in each of the time-series data (1) and the time-series data (2) from among the plurality of corresponding section pairs previously selected by the corresponding section pair selection unit 31.

Specially, the similar corresponding section pair selection unit 32 first determines whether or not changes of the two or more corresponding sections selected in the time-series data (1) are mutually similar. Similarly, it is determined whether or not changes of the two or more corresponding sections selected in the time-series data (2) are mutually similar.

Next, if it is determined that the two or more corresponding sections that are similar in each time-series data are present in the time-series data (1) and the time-series data (2), the similar corresponding section pair selection unit 32 determines whether or not the two or more similar corresponding sections of the time-series data (1) and the two or more similar corresponding sections of the time-series data (2) change corresponding to each other, respectively (form the corresponding section pair). When the two or more corresponding section pairs that satisfied the above condition are present, the similar corresponding section pair selection unit 32 selects the corresponding sections (the corresponding section pairs).

Thereafter, the similar corresponding section pair selection unit 32 outputs information specifying the selected corresponding sections that form the corresponding section part to the feature extraction unit 40. Hereinafter, each of the corresponding sections that are present in the same time-series data and mutually similar is referred to as a “similar corresponding section.” Hereinafter, a set of the similar corresponding sections that belong to the same time-series data and are mutually similar is referred to as a “similar corresponding section set.”

For example, a corresponding section 1-m and a corresponding section 2-m, and a corresponding section 1-n and a corresponding section 2-n are previously selected as the corresponding section pairs. In this case, if the graph of the corresponding section 1-m and the graph of the corresponding section 1-n are similar, and the graph of the corresponding section 2-m and the graph of the corresponding section 2-n are similar, the corresponding sections 1-m, 1-n, 2-m, and 2-n are selected as the similar corresponding sections once again. The corresponding sections 1-m and 1-n and the corresponding sections 2-m and 2-n become the similar corresponding section sets, respectively.

The determination on similarity by the similar corresponding section pair selection unit 32 may also be performed by using the correlation coefficient. In this case, the correlation coefficients are obtained between the corresponding sections as a similarity determination target, for example, between the corresponding section 1-m and the corresponding section 1-n and between the corresponding section 2-m and the corresponding section 2-n. When the obtained coefficient has a positive value and exceeds the threshold value (or is more than or equal to the threshold value), the similar corresponding section pair selection unit 32 determines that they are similar. The threshold value is previously set so that the two or more similar corresponding sections can be selected in the time-series data as an input in view of a characteristic of the document set that is the source of the time-series data or a change status of the time-series data.

Further, the determination on similarity by the similar corresponding section selection unit 32 according to the first embodiment may be performed without using the correlation coefficient. For example, the similar corresponding section selection unit 32 can perform the determination on similarity even by a method of using the existing time-series analysis technique. The method of using the time-series analysis technique includes a technique of using the number of inflection points in each corresponding section, a relative position of the inflection position in the corresponding section, and a value of a differential coefficient between the inflection points as determination factors. Even in this case, the determination is performed based on a previously set threshold value. The threshold value may be set in a similar way to the case of using the correlation coefficient.

Here, the case in which the similar corresponding section selection unit 32 determines similarity based on the time-series analysis technique will be described. For example, in FIG. 2, the corresponding section 1-1 and the corresponding section 1-2 increase and then decrease together. Therefore, it can be determined that the corresponding section 1-1 and the corresponding section 1-2 are similar. The corresponding section 2-1 and the corresponding section 2-2 that correspond to the corresponding section 1-1 and the corresponding section 1-2 are also similar. In this case, the similar corresponding section selection unit 32 selects the corresponding section pair of the corresponding section 1-1 and the corresponding section 2-1 and the corresponding section pair of the corresponding section 1-2 and the corresponding section 2-2.

Meanwhile, in FIG. 3; the corresponding section 1-2 and the corresponding section 1-3 monotonically increase together and are similar. However, the corresponding section 2-2 and the corresponding section 2-3 that correspond to the corresponding section 1-2 and the corresponding section 1-3 have differential coefficients that are opposite in sign to each other and are not similar. Therefore, the corresponding section 1-2 and the corresponding section 1-3, and the corresponding section 2-2 and the corresponding section 2-3 doe not construct the similar corresponding section set.

Further, when one or more similar corresponding section sets cannot be selected in each time-series data, the similar corresponding section selection unit 32 may set the threshold value once again to reduce the threshold value used in the above-described similarity determination. In this case, the similar corresponding section selection unit 32 may instruct the correlation degree calculation unit 70 to stop calculating the degree of correlation.

Further, the similar corresponding section selection unit 32 according to the first embodiment can extend the condition of the similar corresponding section. It is described above that the similar corresponding section selection unit 32 further selects the similar corresponding section pair in each of the time-series data (1) and the time-series data (2) from among the plurality of corresponding section pairs previously selected by the corresponding section pair selection unit 31, but this condition can be extended. For example, the corresponding section pair having low similarity may be selected in each of the time-series data (1) and the time-series data (2) from among the plurality of corresponding section pairs previously selected by the corresponding section pair selection unit 31.

For example, in the graph illustrated in FIG. 5, the corresponding section 1-1 and the corresponding section 1-2, and the corresponding section 2-1 and the corresponding section 2-2 are in a similar relationship to each other, respectively. However, the corresponding section 1-1 and the corresponding section 1-3, and the corresponding section 2-1 and the corresponding section 2-3 are not in a similar relationship, respectively. In this case, the corresponding section pair of the corresponding sections 1-1 and 2-1 has a similar relationship to the corresponding section pair of the corresponding sections 1-2 and 2-2 but does not have a similar relationship to the corresponding section pair of the corresponding sections 1-3 and 2-3 in both of the time-series data (1) and the time-series data (2). At this time, the similar corresponding section pair selection unit 32 can also select the corresponding section pair of the corresponding sections 1-3 and 2-3 as well as the corresponding section pair of the corresponding sections 1-1 and 2-1 and the corresponding section pair of the corresponding sections 1-2 and 2-2.

Further, when the corresponding sections that are not in a similar relationship are also selection targets as described above, the similar corresponding section pair selection unit 32 preferably registers a relationship with other corresponding section pairs (whether it is in a similar relationship or a non-similar relationship) for each of the corresponding section pairs.

Here, the corresponding sections to be selected once again by the similar corresponding section pair selection unit 32 are either in a similar relationship or in a non-similar relationship at both the time-series data (1) side and the time-series data (2) side when the two corresponding section pairs are compared. When the two corresponding section pairs are compared, if the two corresponding section pairs are in a similar relationship at one time-series data side but in a non-similar relationship at the other time-series data side, the corresponding section pairs are not selected.

The feature extraction unit 40 specifies the documents (document data) belonging to the two or more corresponding sections selected in each of the plurality of time-series data for each of the corresponding sections and extracts features of the documents specified for each of the corresponding sections. Here, “the feature of the document” also contains “the feature of the document set” specified for each of the corresponding sections. According to the first embodiment, the feature extraction unit 40 specifies the documents belonging to the selected corresponding section of the time-series data (1) and the documents belonging to the selected corresponding section of the time-series data (2) for each of the corresponding sections and further extracts the features of the specified documents. For example, let us assume that the corresponding section 1-1, the corresponding section 2-1, the corresponding section 1-2, the corresponding section 2-2, the corresponding section 1-3, and the corresponding section 2-3 that are illustrated in FIG. 5 are selected. In this case, the feature extraction unit 40 specifies the documents belonging to each of the six corresponding sections and further extracts the feature from each of the specified documents.

The “feature” extracted from the document includes a linguistic expression that characteristically appears in a set of documents belonging to the selected corresponding section. The linguistic expression that characteristically appears includes a linguistic expression that appears at a high frequency as a result of counting the simple appearance frequency of each linguistic expression in the document set belonging to the selected corresponding section, a linguistic expression that appears at relatively high frequency as a result of comparing with the appearance frequency in the parent population of the document set belonging to sections other than the corresponding section or the documents regarded as the analysis target by the information analysis apparatus 1, and a linguistic expression that appears at a relatively low frequency.

For example, in the time-series data (1) illustrated in FIG. 5, if a linguistic expression “effective against cancer” has a high frequency in the document set belonging to the corresponding section 1-1, “effective against cancer” can be a feature of the corresponding section 1-1. For example, if a linguistic expression “good for health” appears at a high frequency in the document set belonging to the corresponding section other than the corresponding section 1-3 of the time-series data (1) and appears at the low frequency in the document set belonging to the corresponding section 1-3, “good for health” can be a feature of the corresponding section 1-3.

In the first embodiment, when meta information such as the document size, the category, classification information, sender information, and an attribute of the sender are attached to each of the documents belonging to the input document sets, the feature extraction unit 40 can extract the meta information as the “feature.”

Specifically, when sender information representing that the sender corresponds to any one of “beginner,” “normal,” and “expert” is attached, the sender information can be used as the feature. For example, if many documents transmitted from the sender, particularly, the “beginner,” are included in the document set belonging to the corresponding section 1-2, the “beginner” is extracted as the “feature” in the corresponding section 1-2.

Further, when the meta information is extracted as the feature, a kind of the meta information is not specifically limited. When the meta information is attached to each of the documents belonging to the input document set, the feature extraction unit 40 can extract the arbitrary meta information as the “feature.” Further, according to the first embodiment, extraction of the feature from the specific document set by the feature extraction unit 40 may be performed, for example, by using an existing text mining technique. The text mining technique is one of the general natural language processing techniques and is not a key feature of the first embodiment of the present invention. Thus, a description of the text mining technique will be omitted.

Further, for example, the “feature” may be extracted by setting the number of information (the linguistic expressions or meta information) to be extracted as the “feature” in advance and extracting information of the set number in order starting from information having the high appearance frequency. Further, the “feature” may be extracted by using the feature score, for example, in the case of using the text mining technique.

In the latter case, the feature extraction unit 40 first selects a feature factor (e.g., a linguistic expression or meta information) for each of the corresponding sections as the extraction target and calculates the feature score on each feature factor. The feature extraction unit 40 determines whether or not the feature score exceeds a set threshold value and extracts the feature factor that exceeds the threshold value as the “feature.”

In this case, calculation of the “feature score” by the feature extraction unit 40 may be performed using the appearance frequency of the feature factor by a variety of statistical analysis techniques. For example, the feature extraction unit 40 may acquire a statistical measure such as the appearance frequency of each feature factor, a log likelihood ratio, a x2 value, a Yates' correction x2 value, a self-mutual information amount, SE, and ESC and use the acquired value as the feature score.

The feature extraction unit 40 may extract set data of the feature factor and the feature score as the “feature.” For example, let us consider that n feature factors are extracted from the corresponding section 1-1. In this case, a feature 1-1 in the corresponding section 1-1 can be expressed by a feature vector including 2n factors such as T1, SC1, T2, SC2, T3, SC3, . . . , Tn, Scn.

Here, “T1 to Tn” represents n feature factors. Specifically, the feature factors T1 to Tn include, for example, the linguistic expression such as “effective against cancer” or meta information attached to the document such as the sender information (the sender is “the beginner”). “SC1 to SCn” are numerical data representing the feature score added to each feature factor. The feature factor may not make a set with the feature score, that is, only the feature factor may be extracted as “the feature.” In this case, “the feature” is expressed by a feature vector including n factors as in a feature 1-1 (T1, T2, T3, . . . , Tn).

The comparison unit 50 acquires a feature distance between the feature extracted from the document belonging to one corresponding section and the feature extracted from the document belonging to another corresponding section for each of the time-series data. According to the first embodiment, when two or more combination sets between the corresponding sections for acquiring the feature distance are present in each time-series data, the feature distance is acquired for each of the sets, and a value of the acquired distance is treated as the vector data.

The time-series data (1) and the time series data (2) illustrated in FIG. 5 will be described as an example. For example, referring to FIG. 5, the corresponding sections 1-1 and 2-1, the corresponding sections 1-2 and 2-2, and the corresponding sections 1-3 and 2-3 are the corresponding section pairs, respectively, so that three corresponding section pairs are present. Let us assume that three corresponding sections, that is, the corresponding sections 1-1, 1-2, and 1-3, were selected in the time-series data (1).

In this case, for example, the feature distance between the feature of the corresponding section 1-1 and the feature of the corresponding section 1-2, the feature distance between the feature of the corresponding section 1-1 and the feature of the corresponding section 1-3, and the feature distance between the feature of the corresponding section 1-2 and the feature of the corresponding section 1-3 are acquired. Each of the acquired feature distances is expressed by a three-dimensional vector.

Similarly, let us assume that three corresponding sections, that is, the corresponding sections 2-1, 2-2, and 2-3, were selected in the time-series data (2). In this case, for example, the feature distance between the feature of the corresponding section 2-1 and the feature of the corresponding section 2-2, the feature distance between the feature of the corresponding section 2-1 and the feature of the corresponding section 2-3, and the feature distance between the feature of the corresponding section 2-2 and the feature of the corresponding section 2-3 are acquired. Each of the acquired feature distances is expressed by a three-dimensional vector.

In the above described example, the feature distance is acquired on all combinations of the corresponding sections selected in each time-series data by the corresponding section selection unit 30. However, according to the first embodiment, the feature distance may be acquired only between the corresponding sections neighboring each other in the time-series data. In the example of FIG. 5, when the feature distance is acquired only between the neighboring corresponding sections, in the time-series data (1), the feature distance between the corresponding sections 1-1 and 1-2 and the feature distance between the corresponding sections 1-2 and 1-3 are acquired. Similarly, in the time-series data (2), the feature distance is acquired on the corresponding sections 2-1 and 2-2 and the corresponding sections 2-2 and 2-3. Even in this case, each feature distance is expressed by vector data.

Further, when only the feature distance between the neighboring corresponding sections is acquired, a calculation amount in the comparison unit 50 can be reduced. In this case, the accuracy of the comparison result performed by the comparison unit 50 tends to degrade compared to the case of acquiring the feature distance on all combinations between the corresponding sections. Preferably, a combination between the corresponding sections for acquiring the feature distance is suitably set according to a use or intended purpose of the information analysis apparatus 1 and a characteristic of the input document set.

In the first embodiment, the comparison unit 50 acquires the feature distance between an arbitrary corresponding section and another corresponding section by using a function (a distance function) for acquiring the feature distance. The distance function is defined in advance and stored in the database. The distance function is a function capable of calculating the feature distance between the feature extracted from the document belonging to the arbitrary corresponding section and the feature extracted from the document belonging to another corresponding section.

In the first embodiment, the distance function is not limited. A function used as the distance function can be suitably set according to a use or intended purpose of the information analysis apparatus 1 and a characteristic of the input document set. Specifically, a function that satisfies the following conditions can be used as the distance function.

(Condition 1)

When two features extracted from two corresponding sections that are a target for acquiring the distance function are completely identical to each other, the feature distance therebetween becomes 0 (zero).

(Condition 2)

When a feature (1) is extracted from a certain corresponding section and a feature (2) is extracted from another certain corresponding section, the distance between the feature (1) and the feature (2) is equal to the distance between the feature (2) and the feature (1) that are reversed in order.

(Condition 3)

When a feature (1), a feature (2), and a feature (3) are present as the features of the three corresponding sections, the distance between the features satisfies the following relationship: “the feature distance between the feature (1) and the feature (3) “≦” the feature distance between the feature (1) and the feature (2)+the feature distance between the feature (2) and the feature (3).”

(Condition 4)

Let us assume that when two features are input to the comparison unit 50, one feature is expressed by a vector including m feature factors, another feature is expressed by a vector including n feature factors, and both of the features include c common feature factors. In this case, the number of non-common feature factors is “m+n−c.” The feature distance monotonically increases depending on the number of the non-common feature factors.

(Condition 5)

Let us assume that when two features are input to the comparison unit 50, one feature is expressed by a vector (a feature vector) of m feature factors and m corresponding feature scores, and another feature is expressed by a vector (a feature vector) of n feature factors and n corresponding feature scores. Further, let us assume that both of the features include c common feature factors. In this case, the difference between the two feature vectors is acquired as in step 5-1 to step 5-3 below, and the size of the difference becomes the feature distance.

(Step 5-1)

First, two input feature vectors are normalized and matched in dimension number. As a result, in each feature vector, a feature factor present only in the other feature factor is given the feature factor and the feature score “0 (zero),” and both of the feature factors of the two feature vectors become common.

(Step 5-2)

On each of the two input feature vectors, the appearing order of the feature score in the feature vector is sorted for each kind of the feature factor. At this time, the feature factors of the same kind (the same linguistic expression or the same meta information) are sorted so that appearing positions of the feature scores in the vector can be identical to each other.

(Step 5-3)

After normalization on the dimension number and the appearing order of the feature score is performed in step 5-1 and step 5-2, a difference vector between the two normalized feature vectors is calculated. The difference vector has a difference between the feature scores of the two feature vectors as a value, and a dimension thereof becomes an (m+n−c) dimension. Thereafter, an absolute value of the size of the acquired difference vector is acquired as a distance (an inter-feature distance) between the two input feature vectors.

The above described conditions 1 to 3 define characteristics of the general distance function. The conditions 4 and 5 represent that when there are many common feature factors in the two input features, in both of the two input factors, the closer the feature score representing the degree of the feature is, the shorter the inter-feature distance is. Further, the conditions 4 and 5 represent that when a feature factor included only in a feature of either side is present, the larger the feature score representing the degree of the feature is, the larger the inter-feature distance is.

For example, let us assume that two input feature vectors are a feature (1) and a feature (2) stated below.

[Feature (1)]

(“Effective against cancer,” 0.8, “no side effects,” 0.6, “document category: advertisement,” 0.85)

[Feature (2)]

(“Work at once,” 0.4, “no side effects,” 0.5, “document category: advertisement,” 0.7)

“Effective against cancer,” “no side effects,” and “work at once” are linguistic expressions that characteristically appear in the documents belonging to each of the corresponding sections. “Document category: advertisement” represents a category of the documents that characteristically appear in the document set belonging to the corresponding section. The numerical values stated next to the feature factors in the features (1) and (2) represent the feature scores of the feature factors, respectively.

Here, when the feature (1) and the feature (2) are normalized as in step 5-1 and step 5-2, the following features are obtained.

[Normalized Feature (1)]

(“Effective against cancer,” 0.8, “no side effects,” 0.6, “work at once,” 0, “document category: advertisement,” 0.85)

[Normalized Feature (2)]

(“Effective against cancer,” 0, “no side effects,” 0.5, “work at once,” 0.4, “document category: advertisement,” 0.7)

Next, when the difference vector of each feature score is acquired in step 5-3, the difference vector is calculated by the following formula:

Difference vector=((0.8−0),(0.6−0.5),(0−0.4),(0.85−0.7))

The formula is developed as follows:

Difference vector=(0.8,0.1,−0.4,0.15)

The absolute value of the size of the difference vector is acquired as the inter-feature distance.

In the conditions 4 and 5, the inter-feature distance is calculated using the number of the feature factors that commonly appear in the two input features, but the first embodiment is not limited thereto. According to the first embodiment, even if the feature factors are not completely common, the inter-feature distance may be acquired using the similar feature factors as the common factors.

In this case, a similarity criterion for determining the feature factors to be treated as the similar feature factors needs to be previously defined and stored in the database 60. If the feature factor is the linguistic expression, the similar feature factor may be defined by using a synonym dictionary or a thesaurus.

Further, after calculating the vector data of the inter-feature distance between the corresponding sections selected by the corresponding section selection unit 30 for each time-series data, the comparison unit 50 compares the acquired inter-feature distance vector of the time-series data with an inter-feature distance of another time-series data. An arbitrary inter-vector distance function may be used for comparison. A cosine distance may be used as an example of the inter-vector distance function.

Next, the comparison unit 50 outputs the comparison result to the correlation degree calculation unit 70 as a value for acquiring the degree of correlation between the input document sets.

In the first embodiment, the correlation degree calculation unit 70 calculates the degree of correlation between the input document set (1) and the input document set (2) based on the comparison result output from the comparison unit 50. The output unit 80 outputs the degree of correlation calculated by the correlation degree calculation unit 70 as the degree of correlation between the input document set (1) and the input document set (2).

In the first embodiment, the degree of correlation is preferably defined to increase as the numerical value (e.g., a cosine distance) representing the comparison result output from the comparison unit 50 decreases, that is, the distance between the vector data of the two inter-feature distances calculated by the comparison unit 50 decreases.

The degree of correlation may be calculated by acquiring a reciprocal of the result of comparing the vector data of the inter-feature distance in the time-series data (1) with the vector data of the inter-feature distance in the time-series data (2) and multiplying a previously set constant by the reciprocal. Further, the degree of correlation may be calculated by subtracting the comparison result of the vector data of the inter-feature distances from a previously set constant.

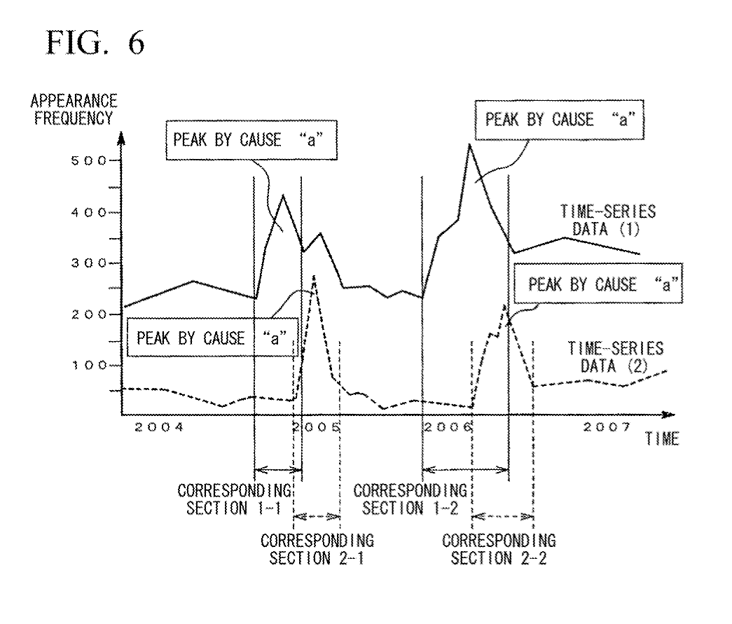

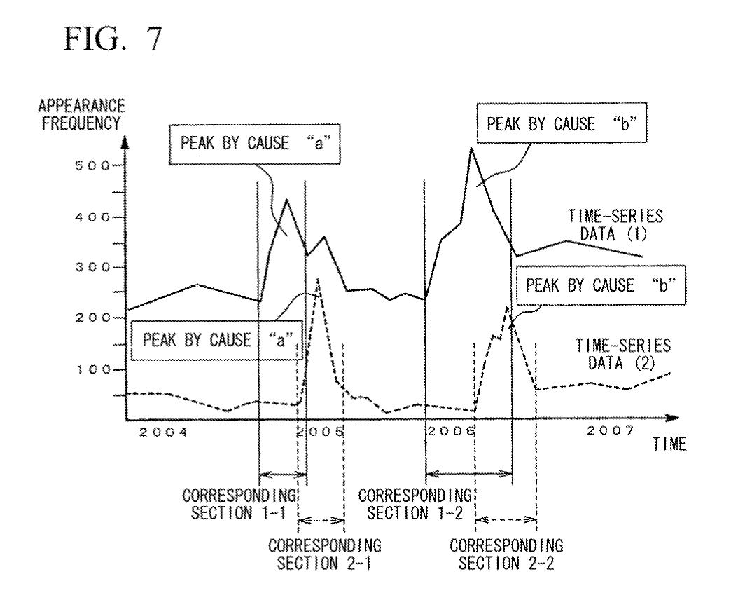

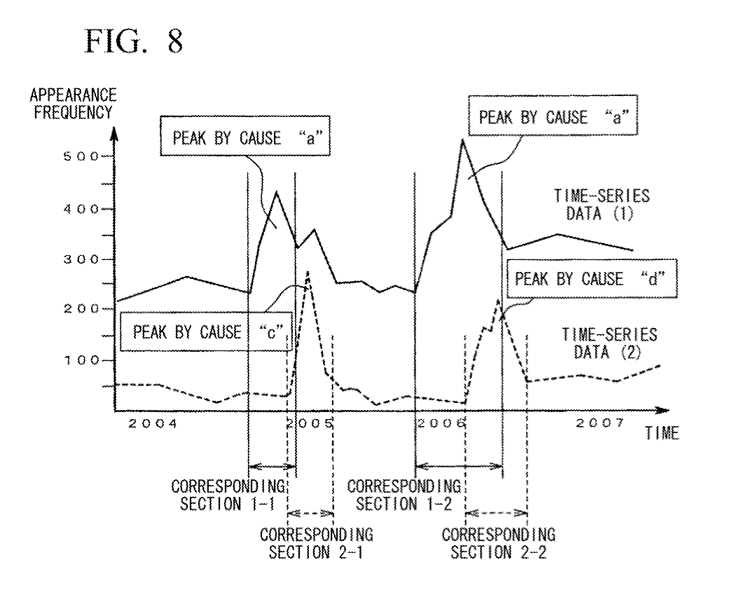

The reasons for defining the degree of correlation as described above will be described with reference to FIGS. 6 to 8. FIG. 6 illustrates an example of the time-series data that changes due to a common cause (e.g., the time-series data having the high degree of correlation). FIG. 7 illustrates another example of the time-series data that changes due to a common cause (e.g., the time-series data having the high degree of correlation). FIG. 8 illustrates another example of time-series data that changes due to different causes (e.g., a case in which the time-series data coincides by chance).

First, let us consider a case in which, for example, as illustrated in FIG. 6, the time-series data (1) and the time-series data (2) are present, the time-series data (1) and the time-series data (2) are very high in correlativity, and the time-series data (1) and the time-series data (2) change by a common cause.

In FIG. 6, the corresponding section 1-1 of the time-series data (1) and the corresponding section 2-1 of the time-series data (2) have peaks generated by a common cause “a.” Similarly, the corresponding section 1-2 of the time-series data (1) and the corresponding section 2-2 of the time-series data (2) have peaks generated by the common cause “a.”

Further, the corresponding section 1-1 and the corresponding section 1-2 in the time-series data (1) are similar in time-series data form to each other. The corresponding section 2-1 and the corresponding section 2-2 in the time-series data (2), which form the corresponding section pair with the corresponding section 1-1 and the corresponding section 1-2, are similar in time-series data form to each other. The four corresponding sections satisfy the condition of the corresponding section set. In this case, the degree of correlation between the time-series data (1) and the time-series data (2) is acquired.

In the technique disclosed in Non-Patent Document 1, the feature of the document set belonging to the time-series data (1) is compared directly with the feature of the document set belonging to the time-series data (2). The degree of correlation therebetween is calculated based on whether or not the common feature factor is present. The correlativity between the corresponding section 1-1 as a partial section of the time-series data (1) and the corresponding section 2-1 as a partial section of the time-series data (2) is high. Focusing the sections, the feature of each of the sections is obtained, and the distance therebetween is obtained.

However, the input document set (1) as the source of the time-series data (1) and the input document set (2) as the source of the time-series data (2) are the document sets that are generally different in characteristics. Even if the document sets change similarly due to the common cause “a,” the feature 1-1 shown in the corresponding section 1-1 and the feature 2-1 shown in the corresponding section 2-1 do not necessarily have the common factor.

However, if the peaks of the corresponding section 1-1 and the corresponding section 1-2 in the same input document set (1) are generated by the common cause “a,” the common factor between the feature 1-1 and the feature 1-2 is considered to be large. Similarly, if the peak of the corresponding section 2-1 and the peak of the corresponding section 2-2 in the same input document set (2) are generated by the common cause “a,” the common factor between the feature 2-1 and the feature 2-2 is considered to be large.

Thus, instead of directly calculating the distance between the feature 1-1 and the feature 2-1, the distance between the feature 1-1 and the feature 1-2 is first calculated, and then the distance between the feature 2-1 and the feature 2-2 is calculated. The degree of correlation can be obtained by comparing the two calculated distances. In this example, the distance between the feature 1-1 and the feature 1-2 is short since there are many common factors. The distance between the feature 2-1 and the feature 2-2 is also short since there are many common factors.

Therefore, the vector data of the inter-feature distance in the time-series data (1) (in this example, only one factor is present) and the vector data of the inter-feature distance in the time-series data (2) (in this example, only one factor is present) decrease together. Thus, the distance therebetween decreases, and the high degree of correlation is calculated.

Meanwhile, let us consider a case in which, as illustrated in FIG. 7, the time-series data (1) and the time-series data (2) are very high in correlativity and change by the common cause (in the same time period), respectively, but in the corresponding section pair of the corresponding section 1-1 and the corresponding section 2-1, a peak is generated by a cause “a,” whereas in the corresponding section pair of the corresponding section 1-2 and the corresponding section 2-2, a peak is generated by a cause “b.”

In the time-series data (1), since the feature 1-1 and the feature 1-2 are different in cause of the peak, the common feature factor is considered to be small, and the distance large. Similarly, in the time-series data (2), since the feature 2-1 and the feature 2-2 are different in cause of the peak, the common feature factor is considered small, and the distance large. Therefore, the vector data of the inter-feature distance in the time-series data (1) (in this example, only one factor) and the vector data of the inter-feature distance in the time-series data (2) (in this example, only one factor) increase together. Thus, the distance therebetween decreases, and the high degree of correlation is calculated.

If the correlativity between the time-series data (1) and the time-series data (2) is very high and the corresponding section pairs change by the common cause, the cause of the change in the corresponding section pair is common because of the premise. Thus, the corresponding section 1-1 and the corresponding section 2-1 have the common change cause, and the corresponding section 1-2 and the corresponding section 2-2 have the common change cause.

In the time-series data (1), the corresponding section 1-1 and the corresponding section 1-2 do not necessarily have the common cause. However, if they have the common cause (as in FIG. 6), as a matter of logic, the corresponding section 2-1 and the corresponding section 2-2 also have the common cause. Meanwhile, if the corresponding section 1-1 and the corresponding section 1-2 do not have the common cause, the corresponding section 2-1 and the corresponding section 2-2 do not have the common cause.

As another example, let us consider a case in which, as illustrated in FIG. 8, there is no correlativity between the time-series data (1) and the time-series data (2), but the correlativity between the corresponding section 1-1 and the corresponding section 2-1 and the correlativity between the corresponding section 1-2 and the corresponding section 2-2 are high due to an accidental coincidence.

Let us assume that the corresponding section 1-1 and the corresponding section 1-2 in the time-series data (1) are generated together by the same cause “a.” In this case, since the feature 1-1 and the feature 1-2 have a lot of common feature factors, the distance is short.

Meanwhile, the corresponding section 2-1 and the corresponding section 2-2 have peaks generated by a cause “c” and a cause “d,” respectively, and have different causes. Thus, the common factor between the feature 2-1 and the feature 2-2 is small, and the distance therebetween is large. Thus, one of the vector data of the inter-feature distance in the time-series data (1) (in this example, only one factor) and the vector data of the inter-feature distance in the time-series data (2) (in this example, only one factor) decreases, and the other increases. Thus, the distance therebetween increases, and the low degree of correlation is calculated.

Of course, if the corresponding section 2-1 and the corresponding section 2-2 are generated by the same cause “c” and the corresponding section 2-2 and the corresponding section 1-2 are generated at the same timing, similarly to the case of FIG. 6, the vector data of the inter-feature distance in the time-series data (1) (in this example, only one factor) and the vector data of the inter-feature distance in the time-series data (2) (in this example, only one factor) decrease together. Thus, the distance therebetween decreases, and the high degree of correlation is erroneously calculated.

However, compared to the case in which the time-series data (1) and the time-series data (2) coincide in peak timing by chance due to arbitrary different causes (as in FIG. 8), regardless of whether or not there is correlativity therebetween, the peaks are generated by a cause that is common in the time-series data (1) and a cause that is common in the time-series data (2). Further, there is little possibility that the two timings will coincide with each other after a constraint condition is tightened.

As described above, in the information analysis apparatus 1, even if the change pattern in the corresponding section of certain time-series data is similar to the change pattern in the corresponding section of another time-series data, if the features of the documents in the both corresponding sections are completely different, it becomes apparent. As a result, according to the information analysis apparatus 1, when the change patterns of the two time-series data coincide with each other, a situation of erroneously determining that there is correlativity can be avoided. The information analysis apparatus 1 is effective in the case of needing to find the document set having the high degree of correlation from an aggregate including a large amount of documents that change by a variety of causes like the document set including document data on the Internet.

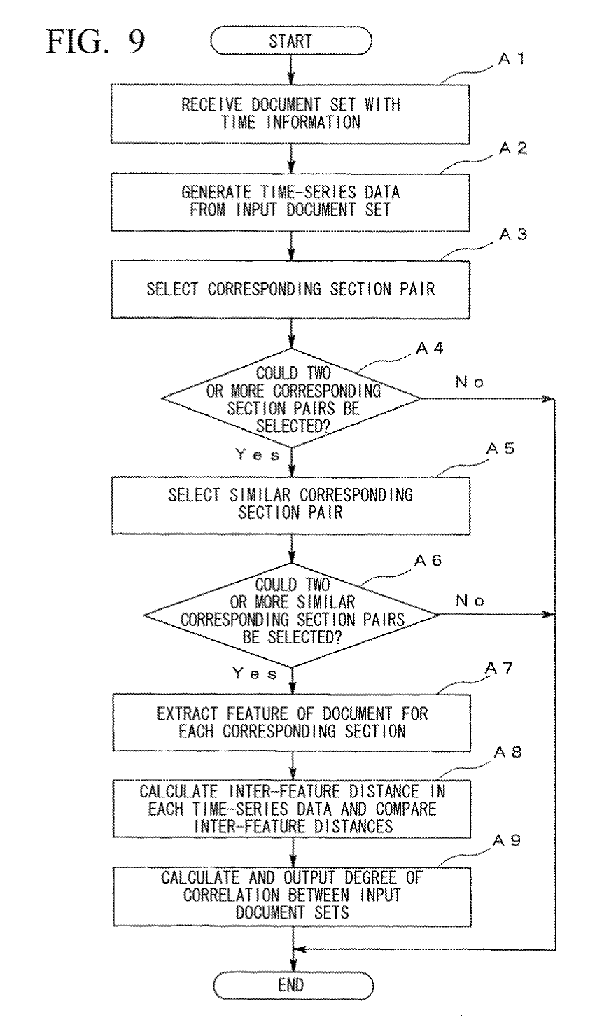

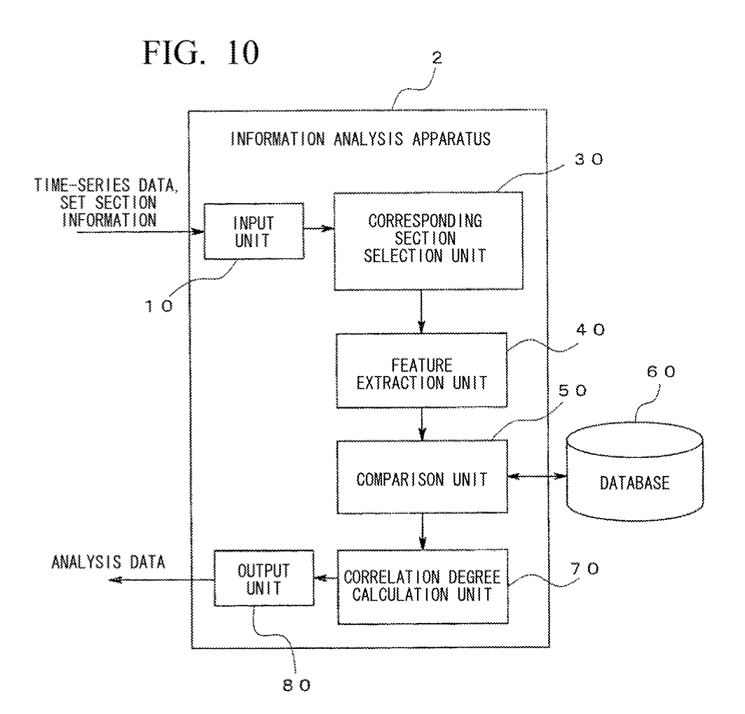

Next, an information analysis method according to a first embodiment of the present invention will be described with reference to FIG. 9. FIG. 9 is a flowchart illustrating the process flow in the information analysis method according to the first embodiment of the present invention. The information analysis method according to the first embodiment of the present invention is executed by operating the information analysis apparatus according to the first embodiment of the present invention illustrated in FIG. 1. Thus, the following description will be made in connection with an operation of the information analysis apparatus 1 with reference to FIG. 1.

As illustrated in FIG. 9, the input unit 10 receives a plurality of document sets as an analysis target (step A1). According to the first embodiment, two document sets are input. One is the input document set (1), and the other is the input document set (2). Each of the document sets includes a plurality of documents with time information.

Next, the time-data generation unit 20 generates the time-series data from the plurality of document sets received by the input unit 10 based on the time information for each of the document sets (step A2). According to the first embodiment, the time-series data generation unit 20 generates the time-series data (1) from the input document set and generates the time-series data (2) from the input document set (2).

Next, the corresponding section selection unit 30 compares the plurality of time-series data obtained from the plurality of document sets and selects two or more sections (corresponding sections), which change corresponding to two or more sections of the other time-series data, from each time-series data.

Specifically, when step A2 is completed, the corresponding section pair selection unit 31 compares the time-series data (1) with the time-series data (2) and selects the corresponding section pair that changes with high correlativity therebetween (step A3). Subsequently, the corresponding section pair selection unit 31 determines whether or not two or more corresponding section pairs that change with high correlativity therebetween could be selected from the time-series data (1) and (2) (step A4).

If it is determined in step A4 that one corresponding section pair could be selected, the corresponding section pair selection unit 31 instructs the correlation degree calculation unit 70 to stop the correlation degree, and the process stops. However, if it is determined in step A4 that two or more corresponding section pairs could be selected, the corresponding section pair selection unit 31 inputs information specifying the selected corresponding section pairs to the similar corresponding section pair selection unit 32.

Next, the similar corresponding section pair selection unit 32 receives information from the corresponding section pair selection unit 31 and selects the similar corresponding section pair in each of the time-series data (1) and the time-series data (2) from among a plurality of corresponding section pairs previously selected (step A5). Subsequently, the similar corresponding section pair selection unit 32 determines whether two or more corresponding section pairs were selected (the total number of corresponding sections is four or more) (step A6).

If it is determined in step A6 that two or more corresponding section pairs were not selected in the time-series data (1) and (2), the similar corresponding section pair selection unit 32 instructs the correlation degree calculation unit 70 to stop the correlation degree, and the process stops. However, if it is determined in step A6 that two or more corresponding section pairs were selected in the time-series data (1) and (2), the similar corresponding section pair selection unit 32 inputs the selected corresponding section pairs to the feature extraction unit 40 once again.

Next, the feature extraction unit 40 receives the information from the similar corresponding section pair selection unit 32, specifies the documents belonging to each of the selected corresponding sections of each time-series data, and extracts the features of the specified documents for each of the corresponding sections (step A7). The feature extraction unit 40 inputs the extracted features to the comparison unit 50.

Next, the comparison unit 50 acquires the inter-feature distance between the feature extracted from one corresponding section and the feature extracted from another corresponding section for each time-series data and mutually compares the acquired inter-feature distances of each time-series data (step A8).

Specifically, the comparison unit 50 calculates the inter-feature distance between a plurality of corresponding sections in each of the time-series data focusing each time-series data and compares the inter-feature distance in the time-series data (1) with the inter-feature distance in the time-series data (2). The comparison unit 50 inputs the comparison result between the inter-feature distance in the time-series data (1) and the inter-feature distance in the time-series data (2) to the correlation degree calculation unit 70.

Subsequently, the correlation degree calculation unit 70 calculates the degree of correlation between the input document sets based on the comparison result input by the comparison unit 50 (step A9). Thereafter, the correlation degree calculation unit 70 outputs the analysis data specifying the degree of correlation, and then the process in the information analysis apparatus 1 is finished.

When the information analysis method in the first embodiment is executed, when the change patterns of the two time-series data coincide with each other by chance, a situation of erroneously determining that there is correlativity can be avoided.

A program in the first embodiment may include a program for executing step A1 to step A9 illustrated in FIG. 9 in a computer. Thus, the information analysis apparatus 1 can be implemented by installing the program in the computer and executing the program. In this case, a central processing unit (CPU) of the computer functions as the time-series data generation unit 20, the corresponding section selection unit 30, the feature extraction unit 40, the comparison unit 50, and the correlation degree calculation unit 70 to perform the process.

Further, the database 60 may be implemented by storing a data file in a storage apparatus such as a hard disk or loading a recording medium storing a data file in a reading apparatus connected with the computer. The storage apparatus that constructs the database 60 may be disposed in the computer in which the program is installed or disposed in another computer connected via a network. The reading apparatus may be connected with the computer in which the program is installed or may be connected with another computer connected via a network.

### Second Embodiment

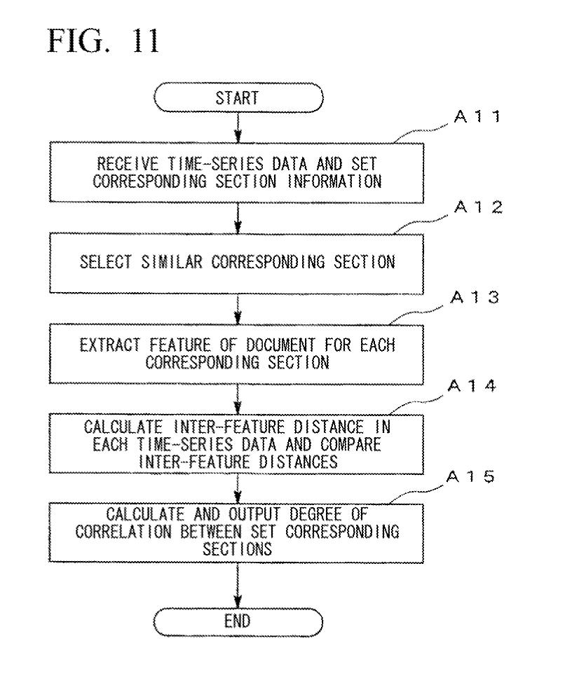

Next, an information analysis apparatus, an information analysis apparatus, and a program according to a second embodiment will be described with reference to FIGS. 10 and 11. First, a configuration of the information analysis apparatus according to the second embodiment will be described with reference to FIG. 10. FIG. 10 is a block diagram illustrating a schematic configuration of the information analysis apparatus according to the second embodiment.

As illustrated in FIG. 10, the information analysis apparatus 2 in the second embodiment does not include the time-series data generation unit (see FIG. 1) and is different from the information analysis apparatus 1 according to the first embodiment in this point. Further, since the time-series data generation unit is not included, the information analysis apparatus 2 is different from the information analysis apparatus 1 according to the first embodiment in a function of each component. The different points with the information analysis apparatus 1 will be described below.

In the second embodiment, the time-series data previously generated from the document set is input to the information analysis apparatus 2. The input unit 10 receives the time-series data. Even in the second embodiment, the two time-series data are input. According to the second embodiment, the corresponding section of one time-series data and the corresponding section of another time-series data are previously set. Information for specifying the previously set corresponding section (the set corresponding section) is also input to the input unit 10.

For example, the input time-series data (1) and (2) are ones illustrated in FIG. 2, and the corresponding section pair of the corresponding section 1-1 and the corresponding section 2-1 that changes with high correlativity with the corresponding section 1-1 is previously set. In this case, information specifying the time-series data (1) and (2), and the set corresponding section 1-1 and the set corresponding section 2-1 is input to the input unit 10.

Further, in the second embodiment, the corresponding section selection unit 30 first selects the corresponding section, which has a change similar to the set corresponding section, on one time-series data. The corresponding section selection unit 30 also selects the corresponding section, which has a change similar to the set corresponding section and corresponds to the corresponding section selected on one time-series data, on another time-series data.

For example, as described above, the time-series data (1) and (2) are ones illustrated in FIG. 2, and the corresponding section 1-1 and the corresponding section 2-1 are previously set. In this case, the corresponding section selection unit 30 selects the section that is a partial section of the time-series data (1) and is similar to the set corresponding section 1-1 as the corresponding section 1-2. Further, the corresponding section selection unit 30 selects the section that is a partial section of the time-series data (2), similar to the set corresponding section 2-1, and changes with high correlativity with the corresponding section 1-2 as the corresponding section 1-2.

Further, in the second embodiment, the feature extraction unit 40 specifies the documents belonging to the set corresponding section of each time-series data and the documents belonging to the selected corresponding sections of each time-series data and extracts the features of the specified documents for each corresponding section.

Further, in the second embodiment, the comparison unit 50 acquires the inter-feature distance between the feature extracted from the set corresponding section and the feature extracted from the selected corresponding section. Even in the secondembodiment, similarly to the first embodiment, the comparison unit 50 calculates the inter-feature distance by using the distance function stored in the database 60. Similarly to the first embodiment, the comparison unit 50 compares the acquired inter-feature distance of each time-series data and inputs the comparison result to the correlation degree calculation unit 70.

Similarly to the first embodiment, the correlation degree calculation unit 70 calculates the degree of correlation based on the comparison result obtained by the comparison unit 50, but in the second embodiment, the degree of correlation between one set corresponding section and another set corresponding section is calculated.

Next, the information analysis method according to the second embodiment will be described with reference to FIG. 11. FIG. 11 is a flowchart illustrating the process flow in the information analysis method according to the second embodiment of the present invention. The information analysis method according to the second embodiment is executed by operating the information analysis apparatus 2 according to the second embodiment illustrated in FIG. 10. Thus, the following description will be made in connection with an operation of the information analysis apparatus 2 with reference to FIG. 10.

As illustrated in FIG. 11, first, the input unit 10 receives the information (the set corresponding section information) specifying the time-series data (1) and (2) as the analysis target and the previously set corresponding section of each time-series data (step A11).

Next, the corresponding section selection unit 30 selects the corresponding section that has a change similar to the set corresponding section of the time-series data (1), and selects the corresponding section, which has a change similar to the set corresponding section of the time-series data (2) and corresponds to the corresponding section selected on the time-series data (1) (step A12).

Next, the feature extraction unit 40 specifies the documents belonging to the set corresponding section of each time-series data and the documents belonging to the selected corresponding sections of each time-series data and extracts the feature of each of the specified documents for each corresponding section (step A13).

Subsequently, the comparison unit 50 acquires the inter-feature distance between the feature extracted from the set corresponding section and the feature extracted from the selected corresponding section, compares the acquired inter-feature distance of each time-series data, and inputs the comparison result to the correlation degree calculation unit 70 (step A14).

Thereafter, the correlation degree calculation unit 70 calculates the degree of correlation between one set corresponding section and another set corresponding section based on the comparison result obtained by the comparison unit 50 (step A15). Thereafter, the correlation degree calculation unit 70 outputs the analysis data specifying the degree of correlation to the outside, and the process in the information analysis apparatus 2 is finished.

As described above, according to the second embodiment, the degree of correlation between the partial section of the time-series data (1) and the partial section of the time-series data (2) can be acquired. Even in the second embodiment, similarly to the first embodiment, a situation of erroneously determining that there is correlativity since the change patterns of the time-series data (1) and (2) coincide with each other by chance can be avoided. The second embodiment is also effective in the case of needing to find the document set having the high degree of correlation from an aggregate including a large amount of documents that change by a variety of causes like the document set including document data on the Internet.

A program in the second embodiment may include a program for executing step A11 to step A15 illustrated in FIG. 11 in a computer. Thus, the information analysis apparatus 2 can be implemented by installing the program in the computer and executing the program. In this case, a CPU of the computer functions as the corresponding section selection unit 30, the feature extraction unit 40, the comparison unit 50, and the correlation degree calculation unit 70 to perform the process. Further, similarly to the case of the first embodiment, the database 60 may be implemented by storing a data file in a storage apparatus such as a hard disk or loading a recording medium storing a data file in a reading apparatus connected with the computer.

### INDUSTRIAL APPLICABILITY

The present invention can be used for analysis of document data on the Internet such as blogs or document data with time information such as the answering record of a call center. The present invention can also be used for acquiring a relevant document set when analyzing a periodically conducted questionnaire survey or a market survey. Further, according to the present invention, since the degree of correlation between the document sets that change over time can be suitably calculated, the present invention can be applied to navigation of a document search or classification of a search result.

### REFERENCE SYMBOLS

1: Information analysis apparatus (first embodiment)
2: Information analysis apparatus (second embodiment)
10: Input unit
20: Time-series data generation unit
30: Corresponding section selection unit
31: Corresponding section pair selection unit
32: Similar corresponding section pair selection unit
40: Feature extraction unit
50: Comparison unit
60: Database
70: Correlation degree calculation unit
80: Output unit

1. An information analysis apparatus that executes information analysis on a document set including documents to which time information is attached, the apparatus comprising:
a corresponding section selection unit that mutually compares a plurality of time-series data generated based on the time information, from a plurality of document sets for each of the document sets and selects two or more sections that change corresponding to each of two or more sections of another time-series data from each time-series data;
a feature extraction unit that specifies the documents belonging to the selected two or more sections for each section on each of the plurality of time-series data and extracts features of the specified documents for each section;
a comparison unit that acquires an inter-feature distance between a feature extracted from one section of the selected two or more sections and a feature extracted from another section for each time-series data and mutually compares the acquired inter-feature distances of each of the time-series data; and
a correlation degree calculation unit that calculates a degree of correlation between the document sets based on the comparison result obtained by the comparison unit.

2. The information analysis apparatus according to claim 1, further comprising:
an input unit that receives the plurality of document sets; and
a time-series data generation unit that generates the plurality of time-series data based on the time information, from the plurality of input document sets for each document set.

3. The information analysis apparatus according to claim 2, wherein, when the input unit receives the two document sets and the time-series data generation unit generates the two time-series data,
the corresponding section selection unit acquires a correlation coefficient between one time-series data and the other time-series data and selects two or more sections in which an absolute value of the correlation coefficient exceeds a set threshold value or is larger than or equal to the threshold value as the two or more sections that change corresponding to each of two or more sections of another time-series data, in each of the two time-series data.

4. The information analysis apparatus according to claim 2, wherein, when the input unit receives the two document sets and the time-series data generation unit generates the two time-series data,
the corresponding section selection unit determines whether or not the selected two or more sections that change corresponding to each other have a similar change on each of the two time-series data, determines whether or not each of the two or more similar sections of one time-series data correspond to each of the two or more similar sections of the other time-series data when the two or more sections that have a similar change are present in both of the two time-series data, and selects the sections when two or more section pairs that change corresponding to each other are present once again,
the feature extraction unit specifies the documents belonging to the two or more sections selected once again for each section on each of the two-time series data, and
the comparison unit acquires the inter-feature distance between one section and another section of the two or more sections selected once again for each of the time-series data.

5. The information analysis apparatus according to claim 1, further comprising an input unit that receives time-series data generated from the document set based on the time information,
wherein, when the input unit receives two time-series data, and one section of one time-series data and one section of the other time-series data that changes corresponding to the one section are previously set,
the corresponding section selection unit selects a section that is similar in change to the previously set one section on the one time-series data and selects a section, which is similar in change to the previously set one section and changes corresponding to the section selected on the one time-series data, on the other time-series data,
the feature extraction unit specifies a document belonging to the previously set one section of each of the two time-series data and a document belonging to the selected section of each of the two time-series data for each section and extracts a feature of each of the specified documents,
the comparison unit acquires an inter-feature distance between a feature extracted from the document belonging to the previously set one section and a feature extracted from the document belonging to the selected section for each time series data and mutually compares the acquired inter-feature distances of each of the time-series data, and
the correlation degree calculation unit calculates the degree of correlation between the previously set sections based on the comparison result obtained by the comparison unit.

6. An information analysis method of executing information analysis on a document set including documents to which time information is attached, the method comprising:
(a) a step of mutually comparing a plurality of time-series data generated based on the time information, from a plurality of document sets for each of the document sets and selecting two or more sections that change corresponding to each of two or more sections of another time-series data from each time-series data;
(b) a step of specifying the documents belonging to the selected two or more sections for each section on each of the plurality of time-series data and extracting features of the specified documents for each section;
(c) a step of acquiring an inter-feature distance between a feature extracted from one section of the selected two or more sections and a feature extracted from another section for each time-series data and mutually comparing the acquired inter-feature distances of each of the time-series data; and
(d) a step of calculating a degree of correlation between the document sets based on the comparison result obtained in step (c).

7. The information analysis method according to claim 6, further comprising:
(e) a step of receiving the plurality of document sets before executing step (a); and
(f) a step of generating the plurality of time-series data, based on the time information, from the plurality of document sets input in step (e) for each document set.

8. The information analysis method according to claim 7, wherein, when the two document sets are input in step (e) and the two time-series data are generated in step (f),
step (a) comprises acquiring a correlation coefficient between one time-series data and the other time-series data and selecting two or more sections in which an absolute value of the correlation coefficient exceeds a set threshold value or is larger than or equal to the threshold value as the two or more sections that change corresponding to each of two or more sections of another time-series data, in each of the two time-series data.

9. The information analysis apparatus according to claim 7, wherein when the two document sets are received in step (e) and the two time-series data are generated in step (f),
step (a) comprises, after selecting the two or more sections that change corresponding to each of two or more sections of another time-series data, determining whether or not the selected two or more sections that change corresponding to each other have a similar change on each of the two time-series data, determining whether or not each of the two or more similar sections of one time-series data and each of the two or more similar sections of the other time-series data change corresponding to each other when the two or more sections that have a similar change are present in both of the two time-series data, and selecting the sections when two or more section pairs that change corresponding to each other are present once again,
step (b) comprises specifying the documents belonging to the two or more sections selected once again for each section on each of the two-time series data, and
step (c) comprises acquiring the inter-feature distance between one section and another section of the two or more sections selected once again for each of the time-series data.

10. The information analysis method according to claim 6, further comprising (g) a step of receiving time-series data generated from the document set based on the time information before executing step (a),
wherein, when two time-series data are received in step (g), and one section of one time-series data and one section of the other time-series data that changes corresponding to the one section are previously set,
step (a) comprises selecting a section that is similar in change to the previously set one section on the one time-series data and selecting a section, which is similar in change to the previously set one section and changes corresponding to the section selected on the one time-series data, on the other time-series data,
step (b) comprises specifying a document belonging to the previously set one section of each of the two time-series data and a document belonging to the selected section of each of the two time-series data and extracting a feature of each of the specified documents for each section,
step (c) comprises acquiring an inter-feature distance between a feature extracted from the document belonging to the previously set one section and a feature extracted from the document belonging to the selected section for each time series data and mutually comparing the acquired inter-feature distances of each of the time-series data, and
step (d) comprises calculating the degree of correlation between the previously set one sections based on the comparison result obtained in step (c).

11. A program for causing a computer to execute information analysis on a document set including documents to which time information is attached, the program further causing the computer to execute:
(a) a step of mutually comparing a plurality of time-series data generated, based on the time information, from a plurality of document sets for each of the document sets and selecting two or more sections that change corresponding to each of two or more sections of another time-series data from each time-series data;
(b) a step of specifying the documents belonging to the selected two or more sections for each section on each of the plurality of time-series data and extracting features of the specified documents for each section;
(c) a step of acquiring an inter-feature distance between a feature extracted from one section of the selected two or more sections and a feature extracted from another section for each time-series data and mutually comparing the acquired inter-feature distances of each of the time-series data; and
(d) a step of calculating a degree of correlation between the document sets based on the comparison result obtained in step (c).

12. The program according to claim 11, further causing the computer to execute:
(e) a step of receiving the plurality of document sets before executing step (a); and
(f) a step of generating the plurality of time-series data, based on the time information, from the plurality of document sets input in step (e) for each document set.

13. The program according to claim 12, wherein, when the two document sets are input in step (e) and the two time-series data are generated in step (f),
step (a) comprises acquiring a correlation coefficient between one time-series data and the other time-series data and selecting two or more sections in which an absolute value of the correlation coefficient exceeds a set threshold value or is larger than or equal to the threshold value as the two or more sections that change corresponding to each of two or more sections of another time-series data, in each of the two time-series data.

14. The program according to claim 12, wherein when the two document sets are received in step (e) and the two time-series data are generated in step (f),
step (a) comprises, after selecting the two or more sections that change corresponding to each of two or more sections of another time-series data, determining whether or not the selected two or more sections that changes corresponding to each other have a similar change on each of the two time-series data, determining whether or not each of the two or more similar sections of one time-series data and each of the two or more similar sections of the other time-series data change corresponding to each other when the two or more sections that have a similar change are present in both of the two time-series data, and selecting the sections when two or more section pairs that change corresponding to each other are present once again,
step (b) comprises specifying the documents belonging to the two or more sections selected once again for each section on each of the two time-series data, and
step (c) comprises acquiring the inter-feature distance between one section and another section of the two or more sections selected once again for each of the time-series data.

15. The program according to claim 11, further causing the computer to execute (g) a step of receiving time-series data generated from the document set based on the time information before executing step (a),
wherein, when two time-series data are received in step (g), and one section of one time-series data and one section of the other time-series data that changes corresponding to the one section are previously set,
step (a) comprises selecting a section that is similar in change to the previously set one section on the one time-series data and selecting a section, which is similar in change to the previously set one section and changes corresponding to the section selected on the one time-series data, on the other time-series data,
step (b) comprises specifying a document belonging to the previously set one section of each of the two time-series data and a document belonging to the selected section of each of the two time-series data and extracting a feature of each of the specified documents for each section,
step (c) comprises acquiring an inter-feature distance between a feature extracted from the document belonging to the previously set one section and a feature extracted from the document belonging to the selected section for each time series data and mutually comparing the acquired inter-feature distances of each of the time-series data, and
step (d) comprises calculating the degree of correlation between the previously set one sections based on the comparison result obtained in step (c).
